(19) United States
(12) Patent Application Publication
(10) Pub. No.: US 2025/0360761 A1
(43) Pub. Date: Nov. 27, 2025

(54) TOW BAR ESTIMATION DEVICE, TOW BAR ESTIMATION METHOD, AND NON-TRANSITORY RECORDING MEDIUM

(71) Applicants: TOYOTA JIDOSHA KABUSHIKI KAISHA, Toyota-shi Aichi-ken (JP); DENSO CORPORATION, Kariya-city Aichi-pref (JP)

(72) Inventor: Ryota Murakami, Meguro-ku Tokyo-to (JP)

(73) Assignees: TOYOTA JIDOSHA KABUSHIKI KAISHA, Toyota-shi Aichi-ken (JP); DENSO CORPORATION, Kariya-city Aichi-pref (JP)

(21) Appl. No.: 19/214,518

(22) Filed: May 21, 2025

(30) Foreign Application Priority Data
May 24, 2024 (JP) 2024-085008

(51) Int. Cl. B60D 1/14; B60R 1/00; G06V 10/26; G06V 10/772; G06V 20/56

(52) U.S. Cl. CPC B60D 1/14; B60R 1/003; G06V 10/273; G06V 10/772; G06V 20/56

(57) ABSTRACT

A tow bar estimation device estimates a tow bar included in an image shot by a camera mounted on a vehicle towing a trailer via the tow bar, extracts a point sequence indicating the tow bar on the image, performs straight line fitting of the point sequence, and estimates whether dirt attached to the camera is included in the image. When a part of the point sequence is located within an area indicating the dirt on the image, the straight line fitting on the other part of the point sequence which is the point sequence with the part of the point sequence located within the area excluded is performed.

### CROSS-REFERENCE TO RELATED APPLICATIONS

This application claims priority to Japanese Patent Application No. 2024-085008 filed May 24, 2024, the entire contents of which are herein incorporated by reference.

### FIELD

The present disclosure relates to tow bar estimation device, tow bar estimation method, and non-transitory recording medium.

### BACKGROUND

PTL 1 (WO 2010/084707) describes a technology of capturing a first image of an object which is optically occluded by dirt, capturing a second image of the same object from a different viewpoint, and reconstructing the optically occluded portion of the first image using information of the second image.

However, the technology described in PTL 1 is not applied to an image which is shot by a camera mounted on a vehicle towing a trailer via a tow bar and which is used to estimate the angle of the linear tow bar (trailer hitch angle). Specifically, in the technology described in PTL 1, extracting point sequence needed for estimating the angle of a linear tow bar and straight line fitting of the extracted point sequence are not performed. Thus, in the technology described in PTL 1, when dirt is attached to the camera mounted on the vehicle towing the trailer via the tow bar, there is a possibility that the angle of the tow bar included in the image shot by the camera cannot be estimated appropriately.

### SUMMARY

In view of the foregoing, an object of the present disclosure is to provide tow bar estimation device, tow bar estimation method, and non-transitory recording medium that can appropriately estimate an angle of a tow bar (trailer hitch angle) included in an image shot by a camera mounted on a vehicle towing a trailer via a tow bar based on the result of straight line fitting even when dirt is attached to the camera.

(1) One aspect of the present disclosure is a tow bar estimation device including a processor configured to: estimate a tow bar included in an image shot by a camera mounted on a vehicle towing a trailer via the tow bar; extract a point sequence indicating the tow bar on the image;
perform straight line fitting of the point sequence; and estimate whether dirt attached to the camera is included in the image, wherein when a part of the point sequence is located within an area indicating the dirt on the image, the processor is configured to perform the straight line fitting on the other part of the point sequence which is the point sequence with the part of the point sequence located within the area excluded.

(2) In the tow bar estimation device of the aspect (1), the processor may be configured to estimate whether the dirt is included in the image by using semantic segmentation.

(3) In the tow bar estimation device of the aspect (1) or (2), the dirt attached to the camera may include rain attached to the camera, snow attached to the camera, and mud attached to the camera, the processor may be configured to estimate whether the rain attached to the camera is included in the image, estimate whether the snow attached to the camera is included in the image, and estimate whether the mud attached to the camera is included in the image, the processor may be configured to estimate whether the rain attached to the camera is included in the image by using a first model obtained by performing learning using first teacher data which is a data set of learning image shot by a learning camera mounted on a learning vehicle towing a learning trailer via a learning tow bar and first label indicating whether the rain attached to the learning camera is included in the learning image, the processor may be configured to estimate whether the snow attached to the camera is included in the image by using a second model obtained by performing learning using second teacher data which is a data set of the learning image and second label indicating whether the snow attached to the learning camera is included in the learning image, and the processor may be configured to estimate whether the mud attached to the camera is included in the image by using a third model obtained by performing learning using third teacher data which is a data set of the learning image and third label indicating whether the mud attached to the learning camera is included in the learning image.

(4) Another aspect of the present disclosure is a tow bar estimation method including: estimating a tow bar included in an image shot by a camera mounted on a vehicle towing a trailer via the tow bar; extracting a point sequence indicating the tow bar on the image; performing straight line fitting of the point sequence; and estimating whether dirt attached to the camera is included in the image, wherein when a part of the point sequence is located within an area indicating the dirt on the image, the straight line fitting on the other part of the point sequence which is the point sequence with the part of the point sequence located within the area excluded is performed.

(5) Another aspect of the present disclosure is a non-transitory recording medium having recorded thereon a computer program for causing a processor to perform a process including: estimating a tow bar included in an image shot by a camera mounted on a vehicle towing a trailer via the tow bar; extracting a point sequence indicating the tow bar on the image; performing straight line fitting of the point sequence; and estimating whether dirt attached to the camera is included in the image, wherein when a part of the point sequence is located within an area indicating the dirt on the image, the straight line fitting on the other part of the point sequence which is the point sequence with the part of the point sequence located within the area excluded is performed.

According to the present disclosure, it is possible to appropriately estimate an angle of a tow bar (trailer hitch angle) included in an image shot by a camera mounted on a vehicle towing a trailer via a tow bar based on the result of straight line fitting even when dirt is attached to the camera.

### BRIEF DESCRIPTION OF DRAWINGS

FIG. 1 is a view showing an example of a vehicle 1 to which a tow bar estimation device 14 of a first embodiment is applied.

FIG. 2A is a view of the vehicle 1, a trailer TR, and a tow bar DB from above.

FIG. 2B is a view showing an example of an image IM including the trailer TR and the tow bar DB shot by a camera 11 mounted on the vehicle 1.

FIG. 3A is a view showing an example of a point sequence PDB indicating the tow bar DB extracted by an extraction unit 3C from the image IM shown in FIG. 2B.

FIG. 3B is a view showing an example of a straight line LDB indicating the tow bar DB generated by a straight line fitting unit 3D from the point sequence PDB shown in FIG. 3A.

FIG. 4A is a view showing an example of a straight line LDB generated by the straight line fitting unit 3D of the tow bar estimation device 14 of the first embodiment when dirt is attached to the camera 11.

FIG. 4B is a view showing an example of a straight line LDB-r generated by a straight line fitting unit of a comparative example when the dirt is attached to the camera 11.

FIG. 5 is a flowchart for explaining an example of a process performed by a processor 143 of the tow bar estimation device 14 of the first embodiment.

FIG. 6 is a view showing an example of the vehicle 1 to which the tow bar estimation device 14 of a second embodiment is applied.

### DESCRIPTION OF EMBODIMENTS

Below, embodiments of tow bar estimation device, tow bar estimation method, and non-transitory recording medium of the present disclosure will be described with reference to the drawings.

### First Embodiment

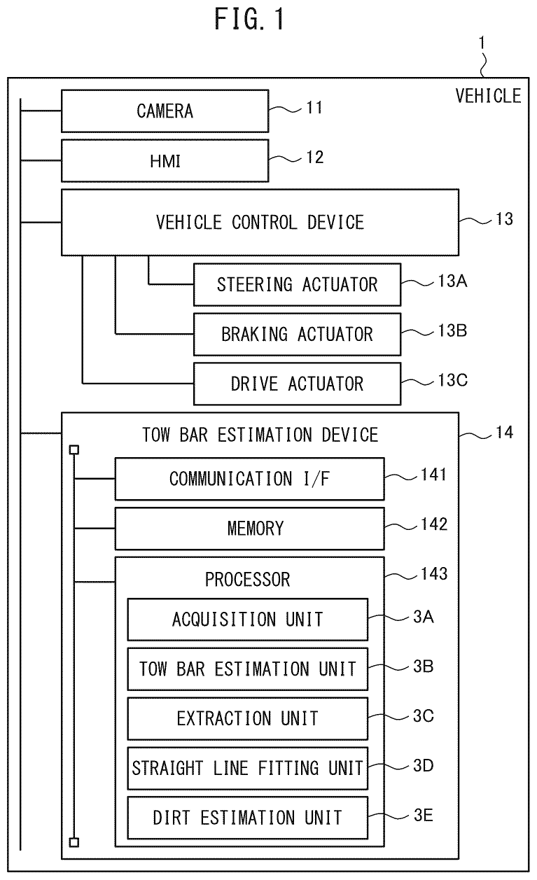

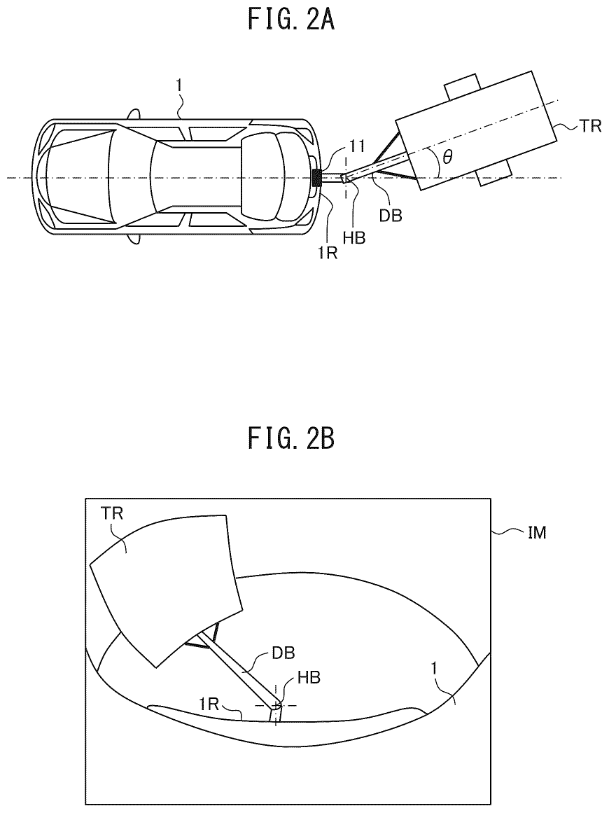

FIG. 1 is a view showing an example of a vehicle 1 to which a tow bar estimation device 14 of a first embodiment is applied. FIG. 2A and FIG. 2B are views showing an example of the relationship between the vehicle 1 shown in FIG. 1, trailer TR, and tow bar DB. In detail, FIG. 2A is a view of the vehicle 1, the trailer TR, and the tow bar DB from above, and FIG. 2B is a view showing an example of an image IM including the trailer TR and the tow bar DB shot by a camera 11 mounted on the vehicle 1.

In the example shown in FIG. 1, FIG. 2A, and FIG. 2B, the vehicle 1 tows the trailer TR via the tow bar DB. The vehicle 1 includes the camera 11, HMI (Human Machine Interface) 12, vehicle control device 13, steering actuator 13A, braking actuator 13B, drive actuator 13C, and the tow bar estimation device 14. The camera 11 is arranged, for example, at a rear end portion IR of the vehicle 1. The camera 11 shoots the rear (the right side in FIG. 2A) of the vehicle 1 and transmits an image (for example, a fisheye lens image, etc.) IM (refer to FIG. 2B) including the trailer TR and tow bar DB to the tow bar estimation device 14.

As shown in FIG. 2A and FIG. 2B, the tow bar DB is affixed to the trailer TR and is connected to the vehicle 1 so as to be rotatable about a hitch ball HB.

In the example shown in FIG. 1, FIG. 2A, and FIG. 2B, the HMI 12 has a function of accepting various operations by a driver of the vehicle 1, and transmits signals indicating the operations by the driver of the vehicle 1 to the vehicle control device 13. The vehicle control device 13 controls the steering actuator 13A, the braking actuator 13B, and the drive actuator 13C based on the signals transmitted from the HMI 12.

The tow bar estimation device 14 is configured by a microcomputer including communication interface (I/F) 141, memory 142, and processor 143. The communication interface 141 has an interface circuit for connecting the tow bar estimation device 14 to the camera 11, the HMI 12, and the vehicle control device 13. The memory 142 stores a program used in a process performed by the processor 143 and various data. The processor 143 has a function as an acquisition unit 3A, a function as a tow bar estimation unit 3B, a function as an extraction unit 3C, a function as a straight line fitting unit 3D, and a function as a dirt estimation unit 3E.

The acquisition unit 3A acquires the image IM (refer to FIG. 2B) including the trailer TR and the tow bar DB shot by the camera 11.

The tow bar estimation unit 3B estimates the tow bar DB included in the image IM acquired by the acquisition unit 3A. In detail, the tow bar estimation unit 3B estimates the tow bar DB included in the image IM based on the image IM acquired by the acquisition unit 3A by using a model obtained by performing learning using teacher data which is a data set of a learning image shot by a learning camera (not shown) mounted on a learning vehicle (not shown) towing a learning trailer (not shown) via a learning tow bar (not shown) and a label indicating the learning tow bar included in the learning image.

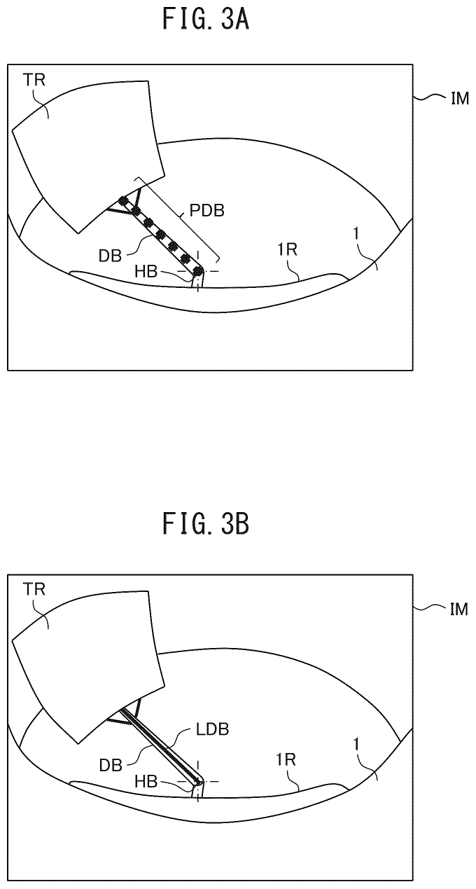

The extraction unit 3C extracts a point sequence PDB (refer to FIG. 3A) on the image IM indicating the tow bar DB estimated by the tow bar estimation unit 3B.

The straight line fitting unit 3D generates a straight line LDB (refer to FIG. 3B) indicating the tow bar DB by performing straight line fitting of the point sequence PDB extracted by the extraction unit 3C. The straight line LDB generated by the straight line fitting unit 3D is used to estimate, for example, an angle of the tow bar DB (hitch angle θ (refer to FIG. 2A) of the trailer TR) included in the image IM.

FIG. 3A and FIG. 3B are views showing an example of the point sequence PDB indicating the tow bar DB extracted by the extraction unit 3C from the image IM shown in FIG. 2B and the like. In detail, FIG. 3A shows the example of the point sequence PDB indicating the tow bar DB extracted by the extraction unit 3C from the image IM shown in FIG. 2B, and FIG. 3B shows an example of the straight line LDB indicating the tow bar DB generated by the straight line fitting unit 3D from the point sequence PDB shown in FIG. 3A.

As described above, in the example shown in FIGS. 2B, 3A, and 3B, dirt is not attached to the camera 11 (specifically, the lens of the camera 11). Conversely, dirt such as rain, snow, and mud may be attached to the camera 11 when, for example, it is raining or snowing, or when the vehicle 1 is traveling on an unpaved road.

Thus, in the example shown in FIG. 1 to FIG. 3B, the measures described below are taken so that the angle of the tow bar DB (the hitch angle θ of the trailer TR) included in the image IM can be appropriately (accurately) estimated based on the straight line LDB generated by the straight line fitting unit 3D even when dirt such as rain, snow, mud, etc., is attached to the camera 11.

The dirt estimation unit 3E estimates whether the dirt attached to the camera 11 is included in the image IM shot by the camera 11. In detail, the dirt estimation unit 3E estimates whether the dirt attached to the camera 11 is included in the image IM shot by the camera 11 based on the image IM acquired by the acquisition unit 3A by using a model obtained by performing learning using teacher data which is a data set of a learning image shot by the learning camera (not shown) mounted on the learning vehicle (not shown) towing the learning trailer (not shown) via the learning tow bar (not shown) and a label indicating whether the dirt attached to the learning camera is included in the learning image. Specifically, the dirt estimation unit 3E estimates whether the dirt attached to the camera 11 is included in the image IM shot by the camera 11 using, for example, semantic segmentation.

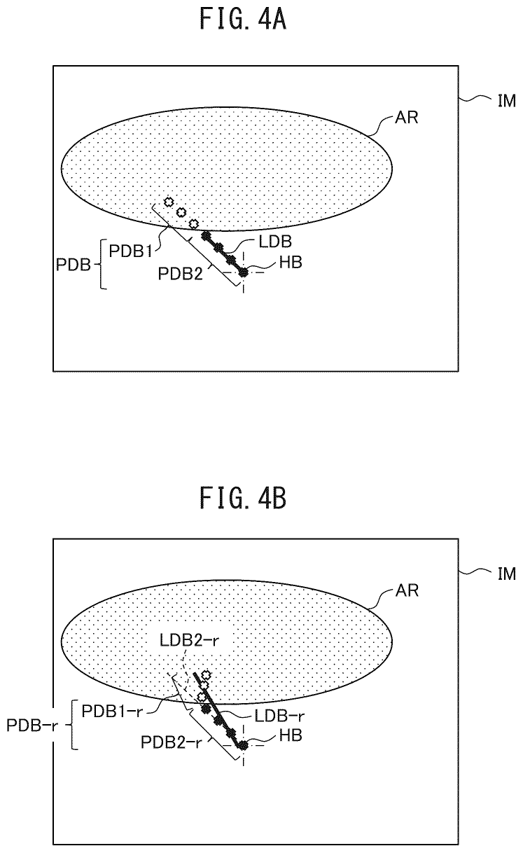

FIG. 4A and FIG. 4B are views showing comparison between an example of the straight line LDB generated by the straight line fitting unit 3D of the tow bar estimation device 14 of the first embodiment when the dirt is attached to the camera 11, and an example of the straight line LDB-r generated by the straight line fitting unit of a comparative example when the dirt is attached to the camera 11. In detail, FIG. 4A shows the example of the straight line LDB generated by the straight line fitting unit 3D of the tow bar estimation device 14 of the first embodiment when the dirt is attached to the camera 11, and FIG. 4B shows the example of the straight line LDB-r generated by the straight line fitting unit of the comparative example when the dirt is attached to the camera 11.

In the comparative example shown in FIG. 4B, a part PDB1-r of the point sequence PDB-r extracted by the extraction unit is located within an area AR indicating the dirt (raindrops) attached to the camera 11 on the image IM. As shown in FIG. 4B, due to refraction of light passing through the raindrops and the like, the part PDB1-r of the point sequence PDB-r is located out of a straight line LDB2-r (the straight line LDB (refer to FIG. 3B) generated by the straight line fitting unit 3D of the tow bar estimation device 14 of the first embodiment when the dirt is not attached to the camera 11) including the other part PDB2-r of the point sequence PDB-r, the other part PDB2-r is located outside the area AR indicating the dirt. Thus, in the comparative example shown in FIG. 4B, the straight line LDB-r located out of the straight line LDB2-r including the other part PDB2-r of the point sequence PDB-r is generated based on the part PDB1-r and the other part PDB2-r of the point sequence PDB-r by the straight line fitting unit. As a result, in the comparative example shown in FIG. 4B, the angle of the tow bar DB (the hitch angle θ of the trailer TR) included in the image IM shot by the camera 11 may be inappropriately estimated.

Conversely, in the example shown in FIG. 4A (example of the straight line LDB generated by straight line fitting unit 3D of the tow bar estimation device 14 of the first embodiment), since the part PDB1 of the point sequence PDB extracted by the extraction unit 3C is located within the area AR on the image IM indicating the dirt estimated by the dirt estimation unit 3E, the straight line fitting unit 3D performs the straight line fitting on the other part PDB2 of the point sequence PDB which is the point sequence with the part PDB I of the point sequence PDB located within the area

AR excluded, and generates the straight line LDB used to estimate the angle of the tow bar DB (hitch angle θ of the trailer TR) included in the image IM. Thus, in the example shown in FIG. 4A, the angle of the tow bar DB (hitch angle θ of the trailer TR) can be appropriately estimated even when the part PDB1 of the point sequence PDB extracted by the extraction unit 3C is located within the area AR on the image IM indicating the dirt attached to the camera 11.

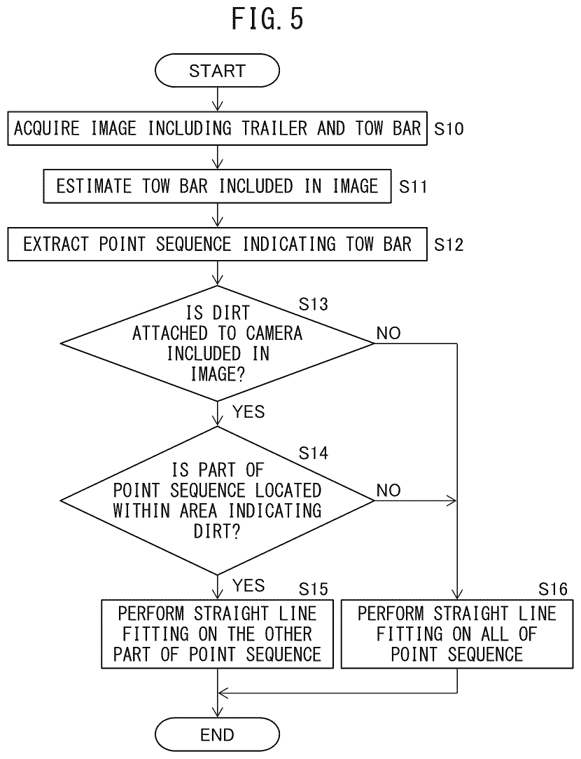

FIG. 5 is a flowchart for explaining an example of the process performed by the processor 143 of the tow bar estimation device 14 of the first embodiment.

In the example shown in FIG. 5, at step S10, the acquisition unit 3A acquires the image IM including the trailer TR and the tow bar DB shot by the camera 11.

At step S11, the tow bar estimation unit 3B estimates the tow bar DB included in the image IM acquired at step S10.

At step S12, the extraction unit 3C extracts the point sequence PDB on the image IM indicating the tow bar DB estimated at step S11.

At step S13, the dirt estimation unit 3E estimates whether the dirt attached to the camera 11 is included in the image IM acquired at step S10. When YES, the process proceeds to step S14, and when NO, the process proceeds to step S16.

At step S14, for example, the straight line fitting unit 3D determines whether the part PDB1 of the point sequence PDB extracted at step S12 is located within the area AR on the image IM indicating the dirt estimated at step S13. When YES, the process proceeds to step S15, and when NO, the process proceeds to step S16.

At step S15, the straight line fitting unit 3D performs the straight line fitting on the other part PDB2 of the point sequence PDB.

At step S16, the straight line fitting unit 3D performs the straight line fitting of all of the point sequence PDB.

### Second Embodiment

The vehicle 1 to which the tow bar estimation device 14 of a second embodiment is applied is configured in the same manner as the vehicle 1 to which the tow bar estimation device 14 of the first embodiment is applied, except for the points described below.

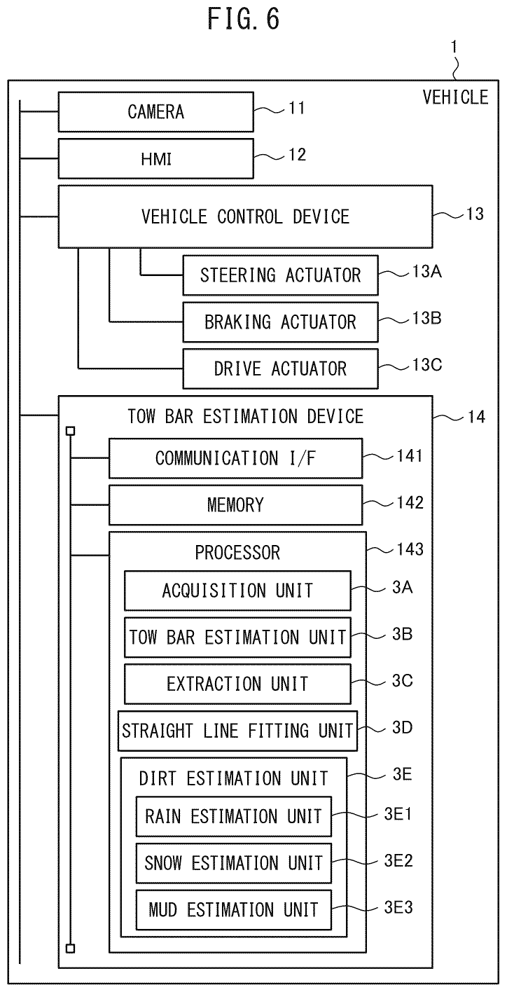

FIG. 6 is a view showing an example of the vehicle 1 to which the tow bar estimation device 14 of the second embodiment is applied. In the example shown in FIG. 6, the dirt estimation unit 3E includes rain estimation unit 3E1 for estimating whether rain attached to the camera 11 is included in the image IM, snow estimation unit 3E2 for estimating whether snow attached to the camera 11 is included in the image IM, and mud estimation unit 3E3 for estimating whether mud attached to the camera 11 is included in the image IM.

Specifically, in the example shown in FIG. 6, the dirt estimation unit 3E has a function for identifying whether the dirt attached to the camera 11 is the rain, the snow, or the mud. The dirt attached to the camera 11 estimated by the dirt estimation unit 3E includes the rain attached to the camera 11, the snow attached to the camera 11, and the mud attached to the camera 11.

The rain estimation unit 3E1 estimates whether the rain attached to the camera 11 is included in the image IM by using a first model (rain estimation model) obtained by performing learning using first teacher data which is a data set of a learning image shot by the learning camera (not shown) mounted on the learning vehicle (not shown) towing the learning trailer (not shown) via the learning tow bar (not shown) and a first label indicating whether the rain attached to the learning camera is included in the learning image.

The snow estimation unit 3E2 estimates whether the snow attached to the camera 11 is included in the image IM by using a second model (snow estimation model) obtained by performing learning using second teacher data which is a data set of a learning image shot by the learning camera and a second label indicating whether the snow attached to the learning camera is included in the learning image.

The mud estimation unit 3E3 estimates whether the mud attached to the camera 11 is included in the image IM by using a third model (mud estimation model) obtained by performing learning using third teacher data which is a data set of a learning image shot by the learning camera and a third label indicating whether the mud attached to the learning camera is included in the learning image.

As described above, although the embodiments of the tow bar estimation device, the tow bar estimation method, and the non-transitory recording medium of the present disclosure have been described above with reference to the drawings, the tow bar estimation device, the tow bar estimation method, and the non-transitory recording medium of the present disclosure are not limited to the embodiments described above, and may be appropriately changed without departing from the scope of the present disclosure. The configuration of each example of the embodiment described above may be appropriately combined. In each example of the embodiments described above, the process performed in the tow bar estimation device 14 has been described as software process performed by executing the program, but the process performed by the tow bar estimation device 14 may be process performed by hardware. Alternatively, the process performed by the tow bar estimation device 14 may be process which combines both software and hardware.

Furthermore, the program (the program for realizing the function of the processor 143 of the tow bar estimation device 14) stored in the memory 142 of the tow bar estimation device 14 may be recorded in a computer-readable storage medium (non-transitory recording medium) such as, semiconductor memory, magnetic recording medium, optical recording medium, or the like for providing, distribution or the like.

1. A tow bar estimation device comprising a processor configured to:
estimate a tow bar included in an image shot by a camera mounted on a vehicle towing a trailer via the tow bar;
extract a point sequence indicating the tow bar on the image;
perform straight line fitting of the point sequence; and
estimate whether dirt attached to the camera is included in the image,
wherein when a part of the point sequence is located within an area indicating the dirt on the image, the processor is configured to perform the straight line fitting on the other part of the point sequence which is the point sequence with the part of the point sequence located within the area excluded.

2. The tow bar estimation device according to claim 1, wherein the processor is configured to estimate whether the dirt is included in the image by using semantic segmentation.

3. The tow bar estimation device according to claim 1, wherein the dirt attached to the camera includes rain attached to the camera, snow attached to the camera, and mud attached to the camera,
the processor is configured to estimate whether the rain attached to the camera is included in the image, estimate whether the snow attached to the camera is included in the image, and estimate whether the mud attached to the camera is included in the image,
the processor is configured to estimate whether the rain attached to the camera is included in the image by using a first model obtained by performing learning using first teacher data which is a data set of learning image shot by a learning camera mounted on a learning vehicle towing a learning trailer via a learning tow bar and first label indicating whether the rain attached to the learning camera is included in the learning image,
the processor is configured to estimate whether the snow attached to the camera is included in the image by using a second model obtained by performing learning using second teacher data which is a data set of the learning image and second label indicating whether the snow attached to the learning camera is included in the learning image, and
the processor is configured to estimate whether the mud attached to the camera is included in the image by using a third model obtained by performing learning using third teacher data which is a data set of the learning image and third label indicating whether the mud attached to the learning camera is included in the learning image.

4. A tow bar estimation method comprising:
estimating a tow bar included in an image shot by a camera mounted on a vehicle towing a trailer via the tow bar;
extracting a point sequence indicating the tow bar on the image;
performing straight line fitting of the point sequence; and
estimating whether dirt attached to the camera is included in the image,
wherein when a part of the point sequence is located within an area indicating the dirt on the image, the straight line fitting on the other part of the point sequence which is the point sequence with the part of the point sequence located within the area excluded is performed.

5. A non-transitory recording medium having recorded thereon a computer program for causing a processor to perform a process comprising:
estimating a tow bar included in an image shot by a camera mounted on a vehicle towing a trailer via the tow bar;
extracting a point sequence indicating the tow bar on the image;
performing straight line fitting of the point sequence; and
estimating whether dirt attached to the camera is included in the image,
wherein when a part of the point sequence is located within an area indicating the dirt on the image, the straight line fitting on the other part of the point sequence which is the point sequence with the part of the point sequence located within the area excluded is performed.
